(19) United States
(12) Patent Application Publication
(10) Pub. No.: US 2019/0275569 A1
(43) Pub. Date: Sep. 12, 2019

(54) PIPE CLEANING ROD AND METHOD FOR CLEANING A PIPE

(71) Applicant: TwistOut GmbH, Jona (CH)

(72) Inventor: Jutta JERTRUM, Jona (CH)

(21) Appl. No.: 16/463,169

(22) PCT Filed: Nov. 14, 2017
(86) PCT No.: PCT/EP2017/079221

§ 371 Date: May 22, 2019

(30) Foreign Application Priority Data
Nov. 23, 2016 (CH) 01551/16

(51) Int. Cl. B08B 9/043; B08B 1/00

(52) U.S. Cl. CPC B08B 9/0436; B08B 1/005

(57) ABSTRACT

A pipe cleaning rod is provided. The pipe cleaning rod has a longitudinal axis (X), two ends and a surface. At least a part of the surface of the pipe cleaning rod includes surface variations, in particular in the form of elevations and/or depressions. A method for cleaning a pipe using a pipe cleaning rod is also provided.

### CROSS REFERENCE TO RELATED APPLICATIONS

This application is a U.S. National Phase filing of international patent application number PCT/EP2017/079221 filed Nov. 14, 2017 that claims the priority of Swiss patent application number 01551/16 filed Nov. 23, 2016. The disclosures of these applications are hereby incorporated by reference in their entirety.

### FIELD

The present invention relates to a pipe cleaning rod and a method for cleaning a pipe.

### BACKGROUND

Almost everybody knows the problem: the water in the wash basin or in the bath tub no longer drains away properly and the reason for this is an accumulation of tangled-up hairs stuck together by soap residues, which block the pipe. In order to free the pipe again a chemical drain cleaner is usually used because there is no other way of getting rid of the hairs. The drain cleaner in most cases manages to get rid of the hairs but not without the help of the strong chemicals contained in it, which are capable of breaking up the hairs. Frequently these are alkaline substances such as sodium hydroxide. Further constituents are, for example, chlorine compounds and aluminium. The aluminium is oxidized by the lye, i.e. the alkaline substance, to form hydrogen, and as a result of this reaction a mechanical loosening of the blockage is achieved in conjunction with the generation of heat and gas. However, it is precisely the forming of hydrogen which is problematic because hydrogen together with oxygen from the air can result in a oxyhydrogen gas explosion. This is prevented by the addition of nitrate to the drain cleaner which together with the hydrogen reacts to form ammoniac thereby binding it. All these chemicals are carried away in the waste water to the sewage plant. Due to the aggressiveness of the chemicals on the one hand, and the generation of heat and gas on the other, the blocked pipe is exposed to undue stress and may get damaged due to the chemical cleaning process or totally destroyed in the long term. In addition, the applicant himself is exposed to a danger or better said a health risk. The drain cleaner is highly corrosive and must not get into contact with clothing, the skin or the eyes and the gases developing should not be breathed in because they can irritate the lung. It is also recommended to wear protective clothing during pipe cleaning, in particular protective glasses and gloves, and it should be ensured that the room is well vented.

Even though proper functioning of the drain cleaner is assured in most cases there still exists the desire for an alternative, which is equally reliable, but less aggressive to the environment, the applicant and the pipe to be cleaned.

### SUMMARY

According to an exemplary embodiment of the invention, a pipe cleaning rod is provided. The pipe cleaning rod includes a longitudinal axis (X), two ends and a surface. At least a part of the surface includes surface variations, in particular in the form of elevations and/or depressions, wherein the surface variations are macroscopic and microscopic.

According to another exemplary embodiment of the invention, a method of cleaning a pipe using a pipe cleaning rod is provided. The pipe cleaning rod includes a longitudinal axis (X), two ends and a surface, At least a part of the surface includes surface variations, in particular in the form of elevations and/or depressions, wherein the surface variations are macroscopic and microscopic. The method includes the steps of: inserting the pipe cleaning rod into the pipe; rotating the pipe cleaning rod about the longitudinal axis (X) of the pipe cleaning rod; and guiding the pipe cleaning rod out of the pipe.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1 illustrates a pipe cleaning rod according to an exemplary embodiment of the invention;

FIG. 2 illustrates a pipe cleaning rod with grooves according to an exemplary embodiment of the invention;

FIG. 3 illustrates a pipe cleaning rod with a pointed end according to an exemplary embodiment of the invention;

FIG. 4 illustrates a conically shaped pipe cleaning rod according to an exemplary embodiment of the invention;

FIG. 5 illustrates a conically shaped pipe cleaning rod, with a pointed end, according to an exemplary embodiment of the invention;

FIG. 6 illustrates a pipe cleaning rod with a continuous enwrapping according to an exemplary embodiment of the invention;

FIG. 7 illustrates a flexible pipe cleaning rod according to an exemplary embodiment of the invention;

FIG. 8 illustrates a pipe cleaning rod with a varyingly structured surface according to an exemplary embodiment of the invention;

FIG. 9 illustrates another a pipe cleaning rod with a varyingly structured surface according to an exemplary embodiment of the invention;

FIG. 10 illustrates another a pipe cleaning rod with grooves according to an exemplary embodiment of the invention; and

FIG. 11 illustrates a cut-out of a cross-section through an exemplary pipe cleaning rod with varying unevennesses according to a exemplary embodiment of the invention.

### DETAILED DESCRIPTION

An objective of the present invention includes proposing a device for cleaning the pipe in a simple and environmentally friendly manner. A further objective includes proposing a method for cleaning the pipe in a simple and environmentally friendly manner.

In concrete terms, an exemplary inventive device is a pipe cleaning rod with a longitudinal axis, two ends and a surface, wherein at least a part of the surface is uneven (e.g., the surface, or part of the surface, is one or more of rough, irregular, non-uniform, not flat, includes surface variations, etc.), in particular, the surface defines elevations and/or depressions.

The pipe cleaning rod may be uneven either all over the surface or only on a part of the surface. This part may not be contiguous, i.e. there may be several regions which together form the at least one part of the surface. The “unevennesses” (e.g., surface variations defined by the uneven surface or part of the surface) forms an uneven microscopic and/or macroscopic surface structure, in which the hairs may get caught and become stuck.

In an exemplary embodiment of a pipe cleaning rod according to the invention, which may be combined with other embodiments included herein as long as they do not conflict with each other, the pipe cleaning rod includes at least one of the following materials: (a) wood, in particular bamboo and/or beech; (b) metal, in particular iron and aluminium; (c) metal alloys, in particular non-rusting stainless steel; (d) plastic, in particular polyethylene, polypropylene, polyvinyl chloride or polyethylene terephthalate; (e) rubber/caoutchouc, in particular styrene butadiene caoutchouc, butadiene caoutchouc or butyl caoutchouc; or (f) or a combination therefrom.

If the environmental aspect is most important, the pipe cleaning rod is best manufactured from a material or a combination of materials, which belong to the renewable raw materials, which are biologically degradable, and/or which on disposal do not leave behind or create any poisonous/environment-endangering residues. Such a renewable raw material may be, for example, wood, in particular bamboo, most preferably in an unadulterated, untreated form. Also native woods, be it conifers, deciduous woods or shrubs, may be used, for example pine, fir, spruce, larch, Douglas fir, cypress, yew, willow, poplar, walnut, birch, alder, hazelnut, beech, chestnut, oak, elm, plane, maple, lime, olive tree, lilac, box, rose, apple, pear, quince, damson, plum, cherry or rowan. Moreover, wood is also biologically degradable. Alternatively, so-called bio-plastics which are based on renewable raw materials and biologically degradable plastics may be used. Furthermore, it is possible to use recycled materials such as recycled plastic. Basically, all these listed materials are suitable since they are altogether better for the environment than the use of strong chemicals.

In one embodiment of the pipe cleaning rod according to the invention, which may be combined with any of the embodiments already mentioned or still to be mentioned, unless in contradiction thereto, the unevennesses (e.g., surface variations) are formed by at least one of the following: (a) grains; (b) pins; (c) pimples; (d) fibres; (e) fine hairs; (f) spirals; (g) notches; (h) grooves; (i) scores; (j) cracks; or (k) or a combination therefrom.

Elevations: fine hairs or fibres may be arranged as in the case of a Velcro closure, thus ensuring that the hairs get caught therein. The length of the hairs or fibers is, for example, in a range from 0.5 mm to 1 cm, the thickness however is in a range from 0.05 mm to 0.2 mm. The surface may have a grain structure which ensures a certain roughness. The grain size lies between 15 μm and 1000 μm, depending on how fine the grain structure or how rough the surface shall be. A very fine grain structure corresponds to a grain size of approx. 15 μm to 75 μm, a fine grain structure corresponds to a grain size of approx. 75 μm to 200 μm a medium-sized grain structure corresponds to a grain size of approx. 200 μm to 500 μm and a coarse grain structure corresponds to a grain size of larger than 500 μm. Pins or pimples by contrast typically have a diameter in the range of 100 μm to 1 cm and a height in the range of 100 μm to 3 cm. Spirals winding around the rod may have a diameter of e.g., 0.1 cm to 1 cm and they may be spaced apart from the basic body of the pipe cleaning rod by a distance of 0 cm to 3 cm.

Depressions: notches or grooves may be interrupted or may extend throughout the entire surface having the unevennesses. They may be, for example, rectangular, triangular or semi-round in cross-section, their depth may lie, for example, between 0.1 mm and 0.5 cm and their width may lie, for example, between 0.1 mm and 0.5 cm. A score may have a comparable or identical mass. Cracks may be, for example, hairline cracks which have a depth of several centimeters, but a thickness of merely 0.05 mm to 0.2 mm.

The surface structure or nature formed by the unevenness (e.g., the surface variations such as the elevations and/or depressions) may be formed by a combination of different types of surface variations. Such a combination may be an orderly or arbitrary adjacent arrangement of different types of unevenness or a combination in terms of an association of different unevenness such as a groove the surface of which has a grain structure, or a spiral which is equipped with pimples.

In one embodiment of the pipe cleaning rod according to the invention which may be combined with any of the embodiments already mentioned or still to be mentioned, unless in contradiction therewith, the uneven surface (or uneven part of a surface) (including the elevations and/or depressions) is macroscopic and/or microscopic.

A microscopic surface variation of an uneven surface, or part of a surface, (i.e., one recognizable only under an optical magnification means), is for example a fine grain structure or a hairline crack. A macroscopic surface variation of an uneven surface, or part of a surface, (i.e., one recognizable by the naked eye), is for example a groove with a 2 mm width or pimples 0.5 cm in height.

In one embodiment of the pipe cleaning rod according to the invention which may be combined with any of the embodiments already mentioned or still to be mentioned, unless in contradiction therewith, the surface variations of an uneven surface, or part of a surface, have been formed by staining, sawing, splitting, planning, drilling, scraping, grinding, carving, lasering, turning, milling, engraving, moulding, embossing, punching, driving, stamping or etching.

For example, with a pipe cleaning rod made of wood, a microscopic surface variation of an uneven surface, or part of a surface, in the form of a micro-rough surface can be generated in a first step by grinding and a macroscopic surface variation uneven surface, or part of a surface, in the form of grooves can be generated in a second step by sawing.

In one embodiment of the pipe cleaning rod according to the invention, that may be combined with any of the embodiments already mentioned or still to be mentioned, unless in contradiction therewith, the surface variations of an uneven surface, or part of a surface, is arranged on a continuous and/or interrupted enwrapping which at least partially surrounds the pipe cleaning rod.

Such an enwrapping may be fixedly or detachably connected to the basic body of the pipe cleaning rod. If the latter is the case, the enwrapping may be replaced or even exchanged so as to match the requirement. The enwrapping may be rigid or flexible.

In one embodiment of the pipe cleaning rod according to the invention which may be combined with any of the embodiments already mentioned or still to be mentioned, unless in contradiction therewith, the continuous and/or interrupted enwrapping includes at least one of the following materials: silicone; caoutchouc/rubber; polyester; or a combination therefrom.

If the enwrapping consists, for example, of silicone or caoutchouc, it is flexible and already inherently possesses a “sticky” surface on which hairs get caught. In combination with the uneven surface, or part of a surface, the hair-adhering effect is thereby additionally reinforced.

In one embodiment of the pipe cleaning rod according to the invention which may be combined with any of the embodiments already mentioned or still to be mentioned, unless in contradiction therewith, the pipe cleaning rod is round.

In one embodiment of the pipe cleaning rod according to the invention which may be combined with any of the embodiments already mentioned or still to be mentioned, unless in contradiction therewith, at least one of the ends of the pipe cleaning rod is pointed.

Due to a pointed shape the hair ball in the drain can be pierced or at least partially penetrated, and the reciprocal effective surface (i.e., the surface on which the unevenness and the hairs get into contact with each other), is enlarged, thereby enhancing the adherence of the hairs and thus the cleaning effect.

In one embodiment of the pipe cleaning rod according to the invention which may be combined with any of the embodiments already mentioned or still to be mentioned, unless in contradiction therewith, the pipe cleaning rod is shaped as a cone.

In one embodiment of the pipe cleaning rod according to the invention which may be combined with any of the embodiments already mentioned or still to be mentioned, unless in contradiction therewith, the uneven surface (or part of the surface) is formed, at least partially, by grooves, which are arranged essentially transversely to the longitudinal axis of the pipe cleaning rod.

The grooves may be a plurality of grooves not connected to each other, but it may also be just one groove shaped in form of a spiral along the longitudinal axis of the pipe cleaning rod.

In one embodiment of the pipe cleaning rod according to the invention which may be combined with any of the embodiments already mentioned or still to be mentioned, unless in contradiction therewith, the diameter/the edge lengths of the cross-section of the pipe cleaning rod lie in a range from 1 mm to 30 mm, in particular from 3 mm to 7 mm and/or the length of the pipe cleaning rod lies in the range from 10 cm to 1 cm, in particular from 20 cm to 60 cm.

In one embodiment of the pipe cleaning rod according to the invention which may be combined with any of the embodiments already mentioned or still to be mentioned, unless in contradiction therewith, the pipe cleaning rod is at least partially formed to be flexible.

A flexible embodiment offers the option that the pipe cleaning rod can optimally adapt to the course of the pipe to be cleaned.

The further objective is achieved by a method of cleaning a pipe with the aid of a pipe cleaning rod. Such a method may include: inserting the pipe cleaning rod into the pipe; rotating the pipe cleaning rod about the longitudinal axis (X) of the pipe cleaning rod; and guiding the pipe cleaning rod out of the pipe.

The pipe cleaning rod is inserted into the pipe, until the end initially inserted makes contact with the blockage penetrating it at least partially, so that the hairs of the blockage get caught up at least partially in the end of the pipe cleaning rod. When the pipe cleaning rod is then turned about its longitudinal axis, the hairs are wound around the rod connecting more and more with the pipe cleaning rod. Once the hairs are sufficiently fixed/caught, the rod with the hairs is withdrawn from the pipe, the blockage is cleared, and the water can flow again.

In one embodiment of the method according to the invention which may be combined with each of the embodiments still to be mentioned, unless in contradiction therewith, the method comprises the step of: disposing of the withdrawn pipe cleaning rod, in particular in the household waste.

In contrast to the chemical pipe cleaning agents the pipe cleaning rod can be simply disposed of in the household waste and does not pollute the environment, or at most to a very limited extent. If the pipe cleaning rod is made of a biologically degradable material it can even be disposed of in the biodegradable waste or on the compost heap.

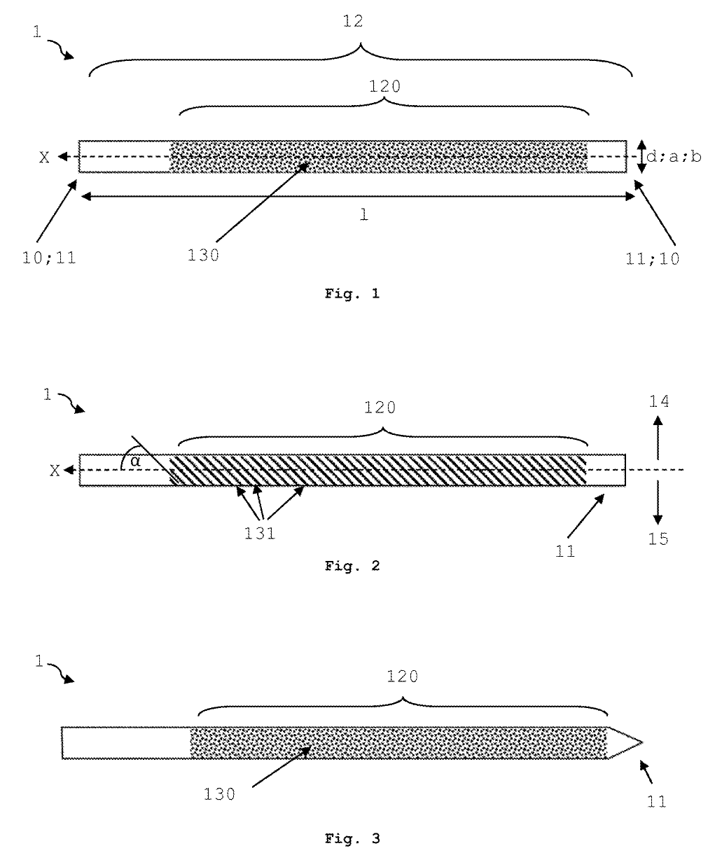

FIG. 1 shows a pipe cleaning rod 1, which includes two ends 10; 11 and a longitudinal axis X. The pipe cleaning rod 1 has a length l and, depending on whether the pipe cleaning rod is shaped round or comprises a rectangular cross-section, has a diameter d or an edge length a, b, for example a rectangular cross-section. The pipe cleaning rod 1 possesses a surface 12, which for a round rod corresponds to its outer surface. A part of this surface 120 includes surface variations 130 (sometimes referred to herein as “unevennesses”). The schematically drawn surface variations 130 shown here includes elevations, such as pimples, pins, grains, fibres, barbs or a combination therefrom. The critical factor is that the at least one part of the surface 120 comprises a structure which ensures that hairs get caught up in it, stuck in it, and/or cling to it. In the example shown the part of the surface 120 having the surface variations 130 is shaped without interruption and is part of an uninterrupted portion of the surface 12 of the pipe cleaning rod 1.

FIG. 2 shows a pipe cleaning rod 1, which is formed similarly to that in FIG. 1. However, the pipe cleaning rod 1 shown here differs from the first one in the way that the surface variations are shaped. For in this embodiment the surface variations include depressions, not elevations. The depressions here strictly speaking are grooves 131 in the surface of the pipe cleaning rod. The depicted grooves extend at an angle α relative to the longitudinal axis X of the pipe cleaning rod 1. The angle α may be between 0° and 180°. Preferably it is between 15° and 60°, in particular between 30° and 45° or between 120° and 165°, in particular between 135° and 150°. If the angle α is between 0° and 90° and if the pipe cleaning rod 1 was inserted with the end 11 first into the pipe to be cleaned, it would seem obvious to clean the pipe by rotating the rod 1 about the longitudinal axis X in direction 15. The hairs are thus wound onto the pipe cleaning rod during the rotational movement. If the angle α is between 90° and 180°, it would seem obvious to clean the pipe by rotating the rod 1 about the longitudinal axis X in direction 14.

FIG. 3 shows a pipe cleaning rod 1 with surface variations 130 on a part of the surface 120. In contrast to the surface variations on the pipe cleaning rods shown in FIGS. 1 and 2 this rod 1 includes a pointed end 11. The end shown is pyramid-shaped or cone-shaped, depending on whether the pipe cleaning rod has a round or a rectangular cross-sectional area. It is, however, not mandatory for the pointed end to comprise an actual tip, a mere tapering, which is flattened at the end, would also be acceptable.

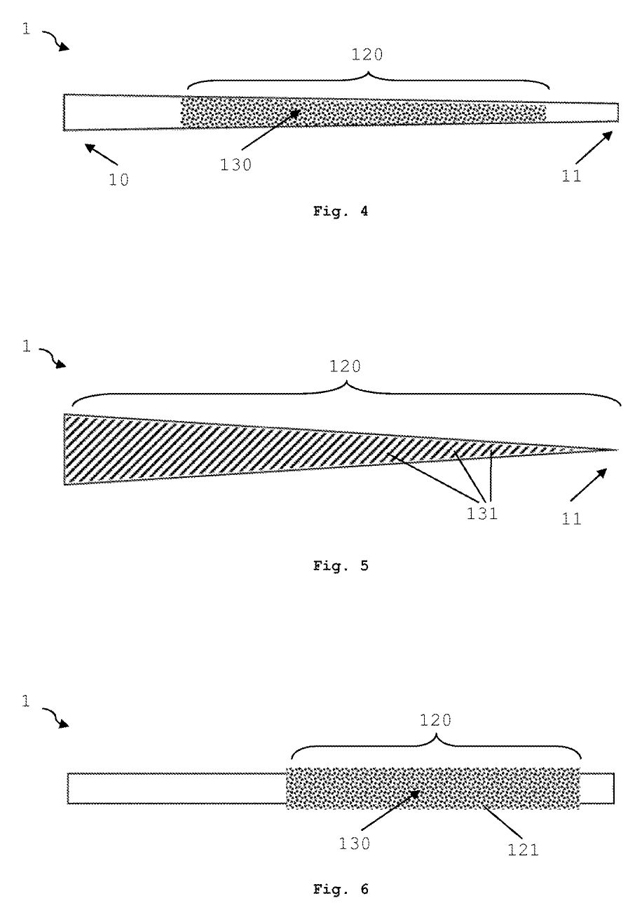

FIG. 4 shows a pipe cleaning rod 1 with surface variations 130 on a part of the surface 120. The basic shape of the pipe cleaning rod 1 is conical. That means that the diameter or the edge length of the cross-sectional area or, in other words, the cross-sectional area of the pipe cleaning rod 1 as such reduces from one end 10 to the other end 11. The end with the smaller cross-sectional area is preferably the end, which is introduced first into the pipe.

FIG. 5 shows a conical pipe cleaning rod 1 which is pointed at one end 11 and surface variations in the form of grooves 131 on the surface 120. In this embodiment the at least one part of the surface comprising the surface variations corresponds to the total enwrapping of the pipe cleaning rod 1.

With the pipe cleaning rod 1 shown in FIG. 6 the surface variations 130 are arranged on a continuous enwrapping 121, which partially surrounds the pipe cleaning rod 1. The enwrapping 121 in this example consists of a flexible material such as silicone and is not fixedly connected to the pipe cleaning rod, but can simply be pulled over it. The enwrapping is thus replaceable or exchangeable. For example, the pipe cleaning rod 1 may be provided with differently designed enwrappings, and depending on the kind of pipe blockage, the best suited enwrapping 121 can then be individually chosen and affixed on the rod 1 as part of the surface 120 with the uneven surface portion 130.

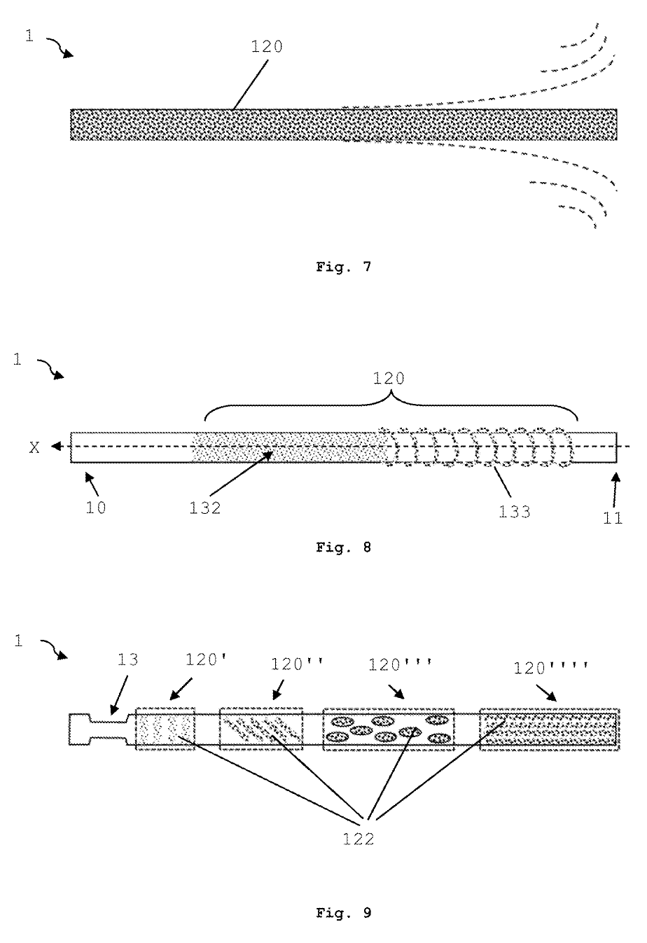

FIG. 7 shows a flexible pipe cleaning rod 1 the total surface 120 of which is provided surface variations. The pipe cleaning rod 1 may be designed so as to be totally flexible or flexible only in a region, which for example may be an end region or a central region. If the pipe cleaning rod 1 is designed to be at least partially flexible, it can be optimally adapted to the geometry of the pipe to be cleaned.

A part of the surface 120 of the pipe cleaning rod 1 shown in FIG. 8 includes two types of surface variations providing an uneven surface, that is pimples 132 on the one hand and spirals 133 on the other, which wind around the pipe cleaning rod 1 along its longitudinal axis X. The spirals 133 are arranged facing the end 11 and the pimples 132 are arranged facing the end 10. It is however not mandatory for a separation into “uneven” regions to be present. Different types of surface variations (e.g., elevations and/or depressions) giving rise to unevenness can also be arranged on the surface 120 in an alternating fashion or in an arbitrary combination.

FIG. 9 shows a pipe cleaning rod 1 with differently designed surfaces 120′, 120″, 120″′, 120″″ with surface variations. The surface variations giving rise to the unevenness are arranged on discontinuous enwrappings 122 and comprise the most varied structures. The discontinuous enwrapping 122 shown are fixedly connected to the pipe cleaning rod 1 and are, for example, realized in the form of stripes of different orientation or in the form of dots. Furthermore, the pipe cleaning rod 1 shown has a gripping region 13, here shown as a tapering, which improves operating and handling the pipe cleaning rod 1 and which may be ergonomically shaped.

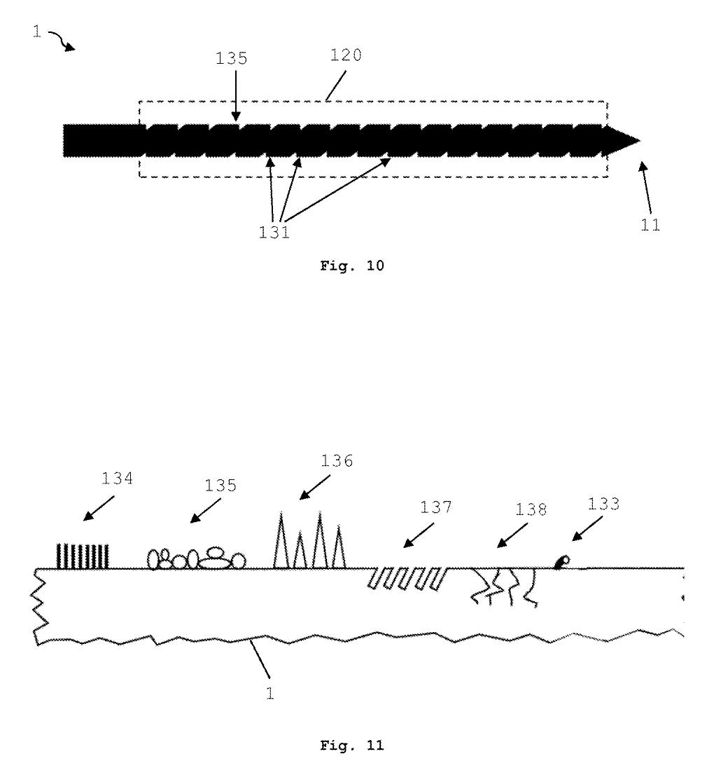

The pipe cleaning rod 1 shown in FIG. 10 is made of bamboo and one of its ends is pointed. The pipe cleaning rod 1 includes two types of surface variations (e.g., elevations and/or depressions) giving rise to unevenness, grooves 131 on the one hand, specifically transverse grooves, on the other hand that part of the surface 120 in which the grooves 131 are arranged is roughed up, meaning that it comprises additional surface variations in form of a grain structure (i.e., in the form of grains 135). The pipe cleaning rod 1 therefore includes two types of surface variations which can be divided into macroscopic (recognizable with the naked eye; grooves 131) and microscopic (recognizable only under a microscope; grains 135) ones and can be present at the same time and/or in combination with at least one part of the surface 120 of the pipe cleaning rod 1.

FIG. 11 shows a cut-out of a cross-section through an exemplary pipe cleaning rod 1, which comprises different kinds of surface variations giving rise to unevenness. These surface variations are visible as fine hairs 134 or fibers, grains 135, pins 136, notches 137 or scores, cracks 138 and a spiral 133. The different elements of one type of surface variation (unevenness) may be designed so as to be identical to each other, (e.g. fine hairs 134 and notches 137) or different from each other (e.g. pins 136 and cracks 138).

Although the invention is illustrated and described herein with reference to specific embodiments, the invention is not intended to be limited to the details shown. Rather, various modifications may be made in the details within the scope and range of equivalents of the claims and without departing from the invention.

### LIST OF REFERENCE SYMBOLS

1 pipe cleaning rod

10, 11 end of pipe cleaning rod

12 surface

120 part of surface with unevennesses

121 enwrapping, continuous

122 enwrapping, interrupted

130 unevennesses (surface variations such as elevations and/or depressions)

131 groove

132 pimple

133 spiral

134 fine hair

135 grain

136 pin

137 notch

138 crack

13 grip, grip region

14 direction of rotation about the longitudinal axis X

15 direction of rotation about the longitudinal axis X

X longitudinal axis of the pipe cleaning rod

d diameter of the pipe cleaning rod

a; b edge lengths of cross-sectional area

l length of pipe cleaning rod

α angle relative to longitudinal axis

1. A pipe cleaning rod comprising. a longitudinal axis (X), two ends and a surface, wherein at least a part of the surface includes surface variations, in particular in the form of elevations and/or depressions, wherein the surface variations are macroscopic and microscopic.

2. The pipe cleaning rod according to claim 1, wherein the pipe cleaning rod includes at least one of the following materials: wood, in particular bamboo and/or beech; metal, in particular iron and aluminium; metal alloys, in particular stainless high-grade steel; plastic, in particular polyethylene, polypropylene, polyvinyl chloride or polyethylene terephthalate; rubber/caoutchouc, in particular styrene butadiene caoutchouc, butadiene caoutchouc or butyl caoutchouc; or a combination therefrom.

3. The pipe cleaning rod according to claim 1, wherein the surface variations include at least one of the following: grains; pins; pimples; fibres; fine hairs; spirals; notches; grooves; scores; cracks; or a combination therefrom.

4. The pipe cleaning rod according to claim 2, wherein the surface variations include at least one of the following: grains; pins; pimples; fibres; fine hairs; spirals; notches; grooves; scores; cracks; or a combination therefrom.

5. The pipe cleaning rod according to claim 1, wherein the surface variations are formed by at least one of staining, sawing, splitting, planning, drilling, scraping, grinding, carving, lasering, turning, milling, engraving, moulding, embossing, punching, driving, stamping and etching.

6. The pipe cleaning rod according to claim 1, wherein the surface variations are arranged on a continuous and/or discontinuous enwrapping, which at least partially surrounds the pipe cleaning rod.

7. The pipe cleaning rod according to claim 6, wherein the continuous and/or discontinuous enwrapping includes at least one of the following materials: silicone; caoutchouc/rubber; polyester; or a combination therefrom.

8. The pipe cleaning rod according to claim 1, wherein the pipe cleaning rod is round.

9. The pipe cleaning rod according to claim 1, wherein at least one of the ends is pointed.

10. The pipe cleaning rod according to claim 1, wherein the pipe cleaning rod is cone-shaped.

11. The pipe cleaning rod according to claim 1, wherein the surface variations are at least partially formed by grooves, in particular by spiral-shaped grooves, which are arranged essentially transversely to the longitudinal axis (X) of the pipe cleaning rod.

12. The pipe cleaning rod according to claim 1, wherein the diameter (d)/the edge lengths (a, b) of the cross-section of the pipe cleaning rod lie within the range from 1 mm to 20 mm.

13. The pipe cleaning rod according to claim 1, wherein the pipe cleaning rod is formed, at least in part, to be flexible.

14. A method for cleaning a pipe with the aid of a pipe cleaning rod, the pipe cleaning rod including a longitudinal axis (X), two ends and a surface, wherein at least a part of the surface includes surface variations, in particular in the form of elevations and/or depressions, wherein the surface variations are macroscopic and microscopic, the method comprising the steps of:
inserting the pipe cleaning rod into the pipe;
rotating the pipe cleaning rod about the longitudinal axis (X) of the pipe cleaning rod; and
guiding the pipe cleaning rod out of the pipe.

15. The method according to claim 14, comprising the further step of disposing of the pipe cleaning rod which has been guided out of the pipe, in particular in the household waste.

16. The pipe cleaning rod according to claim 1, wherein the diameter (d)/the edge lengths (a, b) of the cross-section of the pipe cleaning rod are in a range from 3 mm to 7 mm.

17. The pipe cleaning rod according to claim 1, wherein the length of the pipe cleaning rod is in a range from 10 mm to 100 mm.

18. The pipe cleaning rod according to claim 1, wherein the length of the pipe cleaning rod is in a range from 20 mm to 60 mm.
